(19) United States
(12) Patent Application Publication
(10) Pub. No.: US 2025/0353027 A1
(43) Pub. Date: Nov. 20, 2025

(54) DUAL DISPENSER

(71) Applicant: APTAR FRANCE SAS, LE NEUBOURG (FR)

(72) Inventors: Antoine AILLIOT, FERRIÈRES-HAUT-CLOCHER (FR); Stéphane GATIER, LA SAUSSAYE (FR)

(73) Assignee: APTAR FRANCE SAS, LE NEUBOURG (FR)

(21) Appl. No.: 18/867,056

(22) PCT Filed: May 17, 2023
(86) PCT No.: PCT/FR2023/050703

§ 371 Date: Nov. 19, 2024

(30) Foreign Application Priority Data
May 20, 2022 (FR) FR2204843

(51) Int. Cl. B05B 11/10

(52) U.S. Cl. CPC B05B 11/1084; B05B 11/1047; B05B 11/1083

(57) ABSTRACT

A dual dispenser having two pumps, a first pump with a first actuating pin axially displaceable over a first maximum travel, and a second pump with a second actuating pin axially displaceable over a second maximum travel. The dispenser has a common piston axially displaceable and that acts axially and directly on the first actuating pin to drive it over its first maximum travel. The first maximum travel is greater than the second maximum travel. The dispenser includes reduced a speed transmission mechanism acting between the common piston and the second actuating pin to transmit the axial thrust force of the common piston to the second actuating pin with a reduced speed of the second actuating pin with respect to that of the first actuating pin.

The present invention relates to a dual dispenser two pumps, namely a first pump provided with a first actuating pin that is axially displaceable over a first maximum travel, and a second pump provided with a second actuating pin that is axially displaceable over a second defined maximum travel. The dispenser also comprises a common piston that is axially displaceable and acts axially and directly on the first actuating pin in order to drive it over its first maximum travel.

In the prior art, dual dispensers with doses that can be adjusted by acting on the travel of the actuating pins already exist; by limiting the travel of the actuating pin, only a partial dose is dispensed. It is thus possible to vary the proportion of the two doses that are delivered. This is not the aim of the present invention.

In the prior art, dual dispensers already exist that have different pin travels, one being larger than the other. A catch-up or compensation system, which often consists of a sliding or telescopic sealed connection, is then provided for the shortest travel. Both travels are executed at the same speed, but with a delay or an early end for the shortest travel. This is not the aim of the present invention.

In the prior art, dual dispensers also exist which employ a common pivoting or rotary piston, such as that of document WO 2019/208335 A1. A requirement of the present invention is that the common piston is only displaced axially, without a pivoting or rotary component.

The primary aim of the present invention is to vary, in an overall reducing trend, the speed of the actuating pin having the shortest travel with respect to the speed of the other actuating pin having a longer travel, using a common piston with a purely axial displacement. The aim is not to reduce one dose with respect to the other, nor to compensate for a difference in travel by an initial or final dead stroke, but to actuate the two pins with different speeds.

In order to overcome this technical problem, which is inventive in itself, the present invention proposes a dual dispenser comprising two pumps, namely:
a first pump provided with a first actuating pin that is axially displaceable over a first maximum travel, and
a second pump provided with a second actuating pin that is axially displaceable over a second maximum travel,
the dispenser comprising a common piston that is axially displaceable and that acts axially and directly on the first actuating pin in order to drive it over its first maximum travel,
characterized in that:
the first maximum travel is greater than the second maximum travel, and
the dispenser further comprises reduced speed transmission means acting between the common piston and the second actuating pin in order to transmit the axial thrust force of the common piston to the second actuating pin with a speed of the second actuating pin that is reduced with respect to that of the first actuating pin.

These reduced speed transmission means can also be described more simply as a reducer for the speed of one pin with respect to the other. In other words, these reduced speed transmission means allow the two actuating pins to be displaced simultaneously, but at different, non-zero speeds. As an example, the pin having a travel corresponding to half that of the other pin will be able to be displaced half as quickly as the other one over the totality of the travels of the two pins.

This speed reducer is already inventive in looking into the technical problem, which consists in simultaneously actuating two actuating pins having different travels, with a common piston. It is not a question of actuating the two pins simultaneously with the same speed to the end of the shortest travel, and then stopping the longest travel. This is fully explained above.

Documents US 2016/361732 A1 and JP 4686664 B2 disclose systems in which the speed of the pin that has finished its travel is reduced with respect to that which continues its travel, because the speed of the pin that has finished its travel is zero. This is not within the scope of our invention, since the main claim specifies that the speeds are not zero.

Advantageously, the reduced speed transmission means comprise an actuating cam that comes into contact with the second actuating pin in order to displace it over its second maximum travel, this actuating cam comprising a contact surface that is in dynamic contact with the second actuating pin, this contact surface having a profile that influences the speed of displacement of the second actuating pin. An actuating cam with a regular or linear profile will generate a speed V2 of displacement of the actuating pin that is proportional to the speed V1 of displacement of the other actuating pin. It can then be said that V2=K×V1, with K being a constant less than 1. In contrast, an actuating cam with an irregular or complex profile will generate a speed V2 of displacement of the actuating pin that is not proportional to the speed V1 of displacement of the other actuating pin. It can then be said that V2=f(p)×V1, with p being the slope of the contact surface and with f(p) varying between 0 and 1. It is not excluded for f(p) to be locally constant, i.e. with a regular or linear profile. Many combinations are possible, combining consecutive speed phases that may be proportional and variable. By way of example, it is possible to envisage four distinct phases for V2, during which V1 is constant: a first phase where V2=0, a second phase where V2=V1, a third phase where V2=f(p)×V1 and a fourth phase where V2=K×V1. The reduced speed transmission means only intervene in this precise case during the second, third and fourth phases, the first phase being a dead stroke for the second actuating pin.

It can clearly be seen that the reduced speed transmission means do not prohibit their association with dose adjustment or travel catch-up means: it should be noted that the reduced speed transmission means act during the travels of the two pins, and not before or after.

Because of the reduced speed transmission means, the first and second maximum travels can be executed both in their entirety and simultaneously by pushing axially on the common piston. The speeds of the two actuating pins may be proportional and/or variable.

In accordance with a first embodiment, the reduced speed transmission means comprise a movable element that turns about a vertical rotational axle that is secured to the common piston.

Advantageously, the movable element comprises:
an axle housing for the vertical rotational axle of the common piston,
a rotary drive member that comes into sliding contact on a fixed curved inclined ramp, and
an actuating cam that comes into sliding contact with the second actuating pin.

Preferably, the actuating cam comprises a contact surface in engagement with the second actuating pin, this contact surface being at least partially inclined. However, the contact surface may also be partially planar. Planar and inclined profiles may follow one another.

In accordance with another advantageous aspect of this first embodiment, the movable element may be produced as a single piece.

In accordance with another characteristic of this first embodiment, the movable element may be biassed in rotation towards a starting position by a return spring, which is advantageously produced as a single piece with the movable element.

The advantage of this first embodiment resides in the fact that there is only one single movable part between the common piston and the fixed portion of the dispenser, namely the movable element, which in addition may be as a single piece, including with the return spring. It is sufficient to form the common piston with a vertical rotational axle, for example in the form of a small pin that points downwards. Referring to the curved inclined ramp, it may be formed at the fixed portion of the dispenser in the form of an obliquely truncated segment of a cylinder. Thus, the movable element is the only part to be manufactured and mounted between the common piston and the fixed portion of the dispenser, which makes this first embodiment particularly advantageous.

In accordance with a second embodiment of the invention, the reduced speed transmission means may comprise two articulated levers which e connected together at a common junction point, a first lever being articulated on a bearing or pivot secured to the common piston and a second lever which is articulated on a fixed bearing or pivot, the common junction point being provided with an actuating cam which comes into contact with the second actuating pin.

Advantageously, the actuating cam may be connected to one of the two levers, preferably as a single piece. The actuating cam may have a regular and/or irregular profile in order to induce proportional and/or variable speed phases, as mentioned above.

In accordance with a third embodiment of the invention, the reduced speed transmission means may comprise:
a toothed wheel mounted on a fixed horizontal rotational axle,
a toothed axial pin secured to the common piston and coming into engagement with the toothed wheel in order to drive it in rotation, and
an actuating cam secured to the toothed wheel and coming into contact with the second actuating pin.

Here again, the actuating cam may have a regular and/or irregular profile in order to induce proportional and/or variable speed phases, as mentioned above. The toothed axial pin may be produced as a single piece with the common piston in the form of an elongated tab that points downwards and which is provided with teeth on one of its two vertical edges. The fixed portion of the dispenser may form two bearings for the horizontal rotational axle of the toothed wheel.

In the three embodiments of the invention, although they use very different components, the reduced speed transmission means all interact with the common piston and the fixed portion of the dispenser in order to displace an actuating cam that pushes on the second actuating pin, while the common piston pushes directly and axially on the first actuating pin at the same time. It should be borne in mind that the reduced speed transmission means only act when the first actuating pin is actuated by the common piston. The second actuating pin is therefore displaced simultaneously with the first actuating pin, but at an overall reduced speed, even if the two pins might momentarily be displaced at the same speed over a limited travel.

The invention will now be described below in greater detail with reference to the accompanying drawings that show three embodiments of the invention, given by way of non-limiting example.

In the figures:

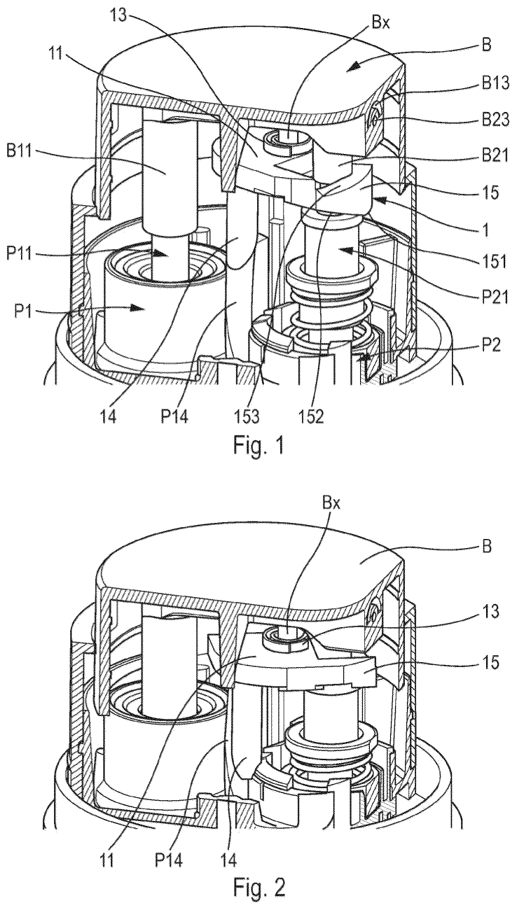

FIG. 1 is a perspective cutaway view of the upper portion of a dispenser in accordance with a first embodiment of the invention in the rest state,

FIG. 2 is a view similar to that of FIG. 1 with the dispenser in the actuated state,

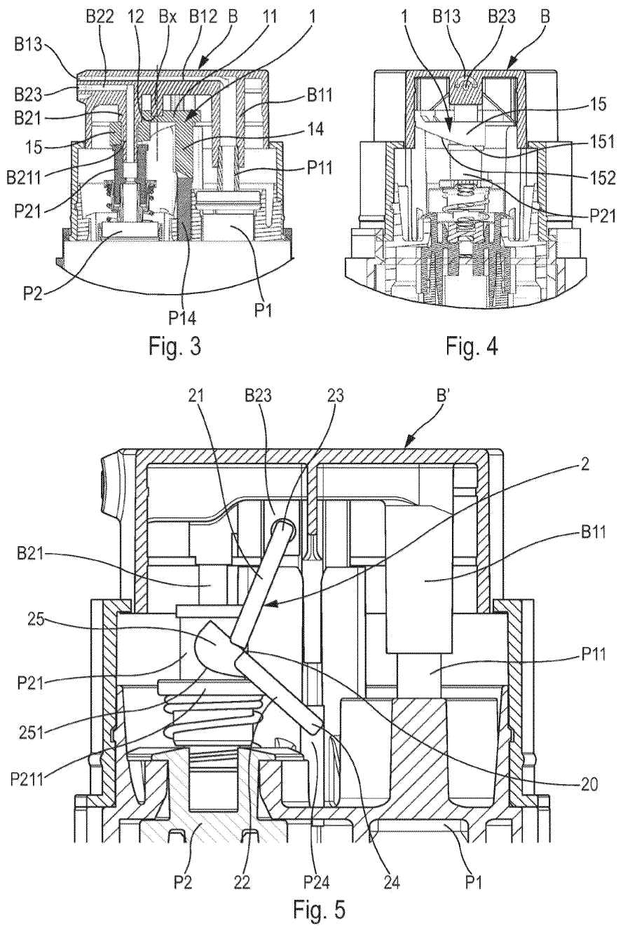

FIGS. 3 and 4 are vertical cross sectional views of the dispenser of FIG. 1 in perpendicular planes,

FIG. 5 is a vertical cutaway perspective view of a dispenser in accordance with a second embodiment of the invention, in the rest state,

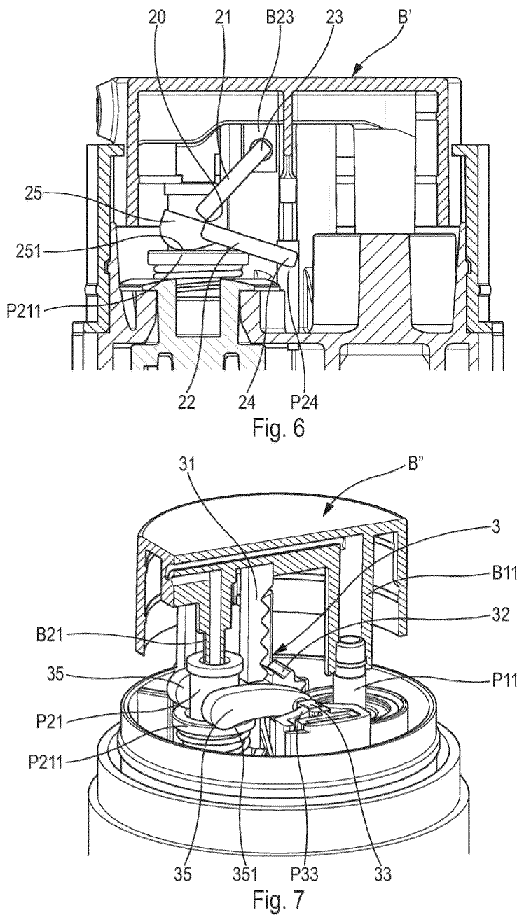

FIG. 6 is a view similar to that of the dispenser of FIG. 5 in the actuated state;

FIG. 7 is a cutaway perspective view of the upper portion of a dispenser in accordance with a second embodiment of the invention, in the rest state,

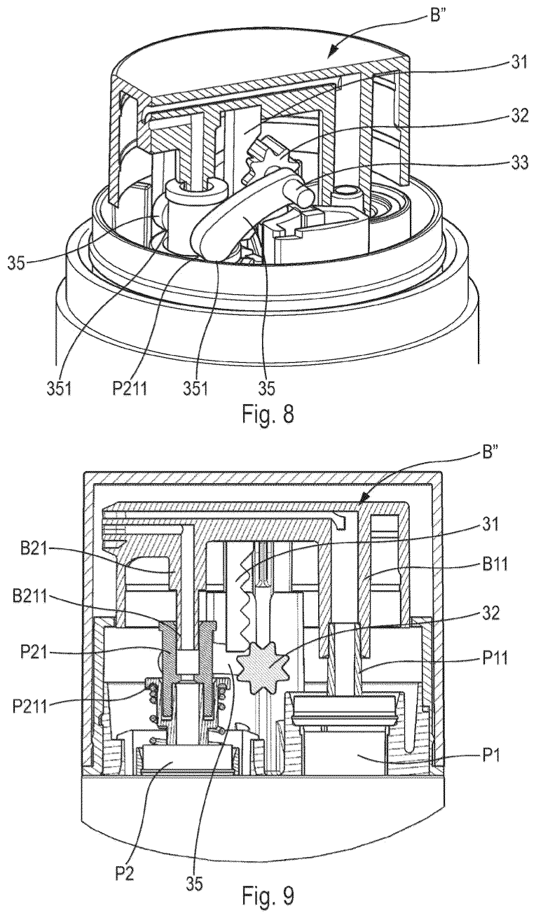

FIG. 8 is a view similar to that of FIG. 7, in the actuated state, and

FIG. 9 is a vertical cross sectional view through the dispenser of FIG. 7.

In the three embodiments of the invention, the dispenser comprises common or similar constituent elements. Firstly, the dispenser comprises two pumps, P1 and P2, which are mounted on respective reservoirs (not shown). The detailed design of the pumps P1 and P2, as well as of the reservoirs, is not critical to the present invention. It is simply necessary to know that the pumps P1 and P2 are fixedly mounted on their respective reservoirs and that only their actuating pins P11 and P21 can be displaced axially back and forth. This design is entirely conventional for a manual pump in the fields of cosmetics, pharmacy, or indeed perfumery. The actuating pins P11 and P21 are returned to the rest position by return springs, which may be internal as in the pump P1, or external as in the pump P2. The reservoirs, the pumps P1 and P2 and all the elements that allow the pumps to be mounted on the reservoirs together constitute a fixed portion of the dispenser. Only the actuating pins P11 and P21 are displaceable with respect to this fixed portion of the dispenser.

In accordance with the invention, the pumps P1 and P2 are different with respect to each other and more particularly, the respective maximum axial travels of the two actuating pins P11 and P21 are different. In the present case, the maximum axial travel of the actuating pin P11 is greater than that of the actuating pin P21. It is therefore necessary to displace the actuating pin P11 over an axial distance that is greater than the actuating pin P21 in order to dispense the full dose of fluid product. It should be noted that when different pumps are used in a dual dispenser, the maximum travels of the two actuating pins of the two pumps are rarely identical.

The technical problem underlying the invention is to actuate these two pins actuating P11 and P22 simultaneously, which necessitates reducing the speed of displacement of the shortest actuating pin P21 with respect to the longest, P11. This technical problem is all the more tangible when the dispenser of the invention comprises a common piston which is axially displaceable along an axis that is parallel to the displacement axes of the two actuating pins P11 and P21. In other words, the common piston is displaced purely axially, without any rotary or pivoting components. The common piston B is directly and axially connected to the actuating pin P11 by a connecting sleeve B11. On the other hand, the common piston B is connected to the actuating pin P21 by a sliding connecting sleeve B21. This implies that the sleeve B21 can slide in a sealed manner inside the actuating pin P21. The connecting sleeve B11 communicates with a dispensing orifice B13 through a conduit B12. Similarly, the connecting sleeve B21 communicates with another distribution orifice B23 through a conduit B22. Without departing from the scope of the invention, the sleeves B11 and B21 could also communicate with a common dispenser orifice.

In accordance with the invention, the reduced speed transmission means act between the common piston and the actuating pin P21 in a manner such as to modulate the speed of displacement of the actuating pin P21 with respect to that of the other actuating pin P11. Overall, the reduced speed transmission means make it possible to reduce the speed of displacement of the actuating pin P21 with respect to the other actuating pin P11.

More particular reference will now be made to FIGS. 1 to 4 in order to describe the reduced speed transmission means in accordance with the first embodiment of the invention. These reduced speed transmission means comprise a movable element 1 of relatively complex design. This movable element 1 firstly comprises a plate 11 which extends substantially horizontally, i.e. perpendicularly to the displacement axes of the actuating pins and of the common piston B. This plate 11 turns about a vertical or axial rotational axle B12 formed by the common piston B. In order to accommodate this rotational axle B12, the plate 11 forms an axle housing 12. The plate 11 is provided with a return spring 13 which makes it possible to return the plate 11 to a rest position. The return spring 13 acts between the plate 11 and the common piston B and may advantageously be produced as a single piece with the plate 11. On the other hand, the movable element 1 comprises a rotational drive member 14, which comes into sliding or gliding contact on a curved inclined ramp P14, which is formed by the fixed portion of the dispenser. By way of example, the drive member 14 may be in the form of a pin that extends downwards from the lower face of the plate 11. The free end of the pin 14 may be inclined in order to promote sliding thereof on the curved inclined ramp P14. The movable element 1 also includes an actuating cam 15 that extends laterally from the plate 11. This actuating cam 15 comprises a contact surface intended to come to bear on the actuating pin P21. The actuating cam 15 also comprises an upper bearing surface 153 on which the connecting sleeve B21 comes to bear. More precisely, it can be seen in FIG. 3 that the sleeve B21 ends in a tube B211, which is sealingly slidably engaged in the actuating pin P21. In other words, the actuating cam 15 is sandwiched between the connecting sleeve B21 and the actuating pin P21, extending thereby around the tube B211. In FIG. 1 and FIG. 4, it should be observed that the contact surface of the cam 15 comprises a plurality of segments, in particular a horizontal segment 151 and an inclined segment 152. This is only a non-limiting embodiment here: it is, of course, possible to envisage more segments or, in contrast, a single segment.

In FIG. 1, as in FIGS. 3 and 4, the common piston B is at rest: the actuating pins P11 and P21 are biassed into the rest position by their respective return springs. The movable element 1 is then biassed into its rest position by the spring 13. The drive member 14 is located at the top of the curved inclined ramp P14. The horizontal segment 151 is in contact with the actuating pin P21.

By pushing axially on the common piston B, the actuating pin P11 will be displaced. The same applies to the actuating pin P21, wherein the axial bearing force is transmitted by the connecting sleeve B21 and the actuating cam 15, the horizontal segment 151 of which bears directly on the actuating pin P21. However, the axial displacement of the piston B also has the effect of causing the movable element 1 to turn about the axis B12 under the action of the actuating cam 14 which slides on the curved inclined ramp P14. As a result, the actuating cam 15 will be displaced horizontally in a manner such as to bring its inclined segment 151 into contact with the actuating pin P21. This is shown in FIG. 2. Since the segment 152 is inclined, the distance between the connecting sleeve B21 and the actuating pin P21 is gradually reduced, which has the effect of reducing the speed of displacement of the displacement pin P21 with respect to that of the other actuating pin P11. In this exemplary embodiment, the inclined segment 152 has a constant slope, such that the speed of displacement of the actuating pin P21 is proportional to or linear with respect to that of the actuating pin P11. It could otherwise have had an inclined segment having a non-constant slope, for example convex or concave, or indeed corrugated.

In the present case with an actuating cam 15 having a horizontal segment 151 and a constant inclined segment 152, the actuating pin P21 is displaced in two distinct phases, namely an initial phase, during which its speed of displacement will be identical to that of the actuating pin P11 (corresponding to the flat segment 151), and a second phase, during which its speed of displacement is reduced with respect to that of the actuating pin P11, but with a constant ratio (corresponding to the inclined segment 152). It will then readily be understood that it is possible to adapt the speed of displacement of the actuating pin P21 with respect to that of the other actuating pin P11 by acting on the configuration of the contact surface (151, 152) of the actuating cam 15.

The speed of rotation of the movable element 1 about the axle B12 may also be modulated by acting on the slope of the curved inclined ramp P14 or the upper bearing surface 153.

Referring now to FIGS. 5 and 6, a dual dispenser of the invention incorporating reduced speed transmission means 2 in accordance with a second embodiment of the invention is shown. The common piston B′ may be similar to the common piston B of the first embodiment, except that the rotational axle B12 has been replaced here by a first bearing with a horizontal axle B23. At the fixed portion of the dispenser, the curved inclined ramp P14 has been replaced by a second bearing with a horizontal axle B24. The two pumps P1 and P2 are identical to those of the first embodiment.

The reduced speed transmission means 2 of this second embodiment comprise two levers 21 and 22 that are movable with respect to one another, while being connected by a common junction point 20. The first lever 21 comprises an end 23 that turns in the axle bearing B23. The second lever 22 comprises an end 24 that turns in the second axle bearing B24. The second lever 22 is provided with an actuating cam 25 that forms a contact surface 251 which comes into contact with the actuating pin P21, which has a maximum travel that is less than that of the other actuating pin P11. The contact surface 251 may be perfectly circular or, in contrast, it may be profiled like that of FIGS. 5 and 6. A circular contact surface will induce a linear displacement of the actuating pin P21 with respect to the other pin P11. In contrast, the profiled contact surface 251 of FIGS. 5 and 6 induces a non-linear or non-proportional displacement with respect to the pin P11. As a consequence, here again, it is possible to modulate the speed of displacement of the actuating pin P21 with respect to that of the other actuating pin P11, by acting on the shape of the contact surface 251.

Referring now to FIGS. 7 to 9, another dual dispenser of the present invention incorporating reduced speed transmission means 3 in accordance with a third embodiment of the invention is shown. The pumps may be identical to the first two embodiments of the invention. The common piston B″ may have a similar design, with the exception of the rotational axle B12 or the axle bearing B23, which is replaced here by a toothed axial pin 31 that extends downwards. These transmission means 3 also comprise a toothed wheel 32 mounted on a horizontal rotational axle 33 received in a fixed axle bearing P33 formed by the fixed portion of the dispenser. These transmission means 3 also comprise two actuating cams 35 which come into engagement with the actuating pin P21, and more particularly with a rim P211 of the actuating pin. The toothed pin 31 meshes with the toothed wheel 32, such that an axial displacement of the common piston B″ has the effect of causing the toothed wheel 32 to turn about its axis 33, thus inducing a pivoting displacement of the two actuating cams 35 which act directly on the actuating pin P21. Here again, as in the first two embodiments of the invention, the contact surface 351 of the two actuating cams 35 may be profiled in order to modulate the speed of displacement of the actuating pin P21 with respect to that of the other actuating pin P11 which is directly acted upon by the common piston B″.

In the three embodiments described above, the two actuating pins P11 and P21 may be displaced simultaneously over their entire respective travels, but at different speeds of displacement. However, it is not excluded that the speeds of displacement of the two pins may be identical over a portion of their travel. Ultimately, however, it can be said that the speed of displacement of the actuating pin P21 is reduced with respect to that of the other actuating pin P11. The actuation speeds of the two pins may be proportional or linear with regular contact surfaces or, in contrast, non-proportional or disjointed, with complex contact surfaces. The first embodiment with its movable element 1 has the advantage that there is only one single part to be added to the dual dispenser: the rotational axle B12 and the curved inclined ramp P14 can be produced as a single piece with their respective component.

The invention thus provides a dual dispenser having different pumps and a common axial piston, the two doses of which can be dispensed simultaneously, despite the difference in travel of the actuating pins of the two pumps.

1. A dual dispenser comprising two pumps, namely:
a first pump provided with a first actuating pin that is axially displaceable over a first maximum travel, and
a second pump provided with a second actuating pin that is axially displaceable over a second maximum travel,
the dispenser comprising a common piston that is axially displaceable and that acts axially and directly on the first actuating pin in order to drive it over its first maximum travel,
wherein:
the first maximum travel is greater than the second maximum travel, and
the dispenser further comprises reduced speed transmission means acting between the common piston and the second actuating pin in order to transmit the axial thrust force of the common piston to the second actuating pin with a speed of the second actuating pin that is reduced with respect to that of the first actuating pin, the speeds of the actuating pins being different and not zero.

2. The dispenser as claimed in claim 1, in which the reduced speed transmission means comprise an actuating cam that comes into contact with the second actuating pin in order to displace it over its second maximum travel, this actuating cam comprising a contact surface that is in dynamic contact with the second actuating pin, this contact surface having a profile that influences the speed of displacement of the second actuating pin.

3. The dispenser as claimed in claim 1, in which the reduced speed transmission means comprise a movable element that turns about a vertical rotational axle that is secured to the common piston, the movable element comprising:
an axle housing for the vertical rotational axle of the common piston,
a rotary drive member that comes into sliding contact on a fixed curved inclined ramp, and
an actuating cam that comes into sliding contact with the second actuating pin.

4. The dispenser as claimed in claim 3, in which the actuating cam comprises a contact surface in engagement with the second actuating pin, this contact surface being at least partially inclined.

5. The dispenser as claimed in claim 3, in which the contact surface is partially planar.

6. The dispenser as claimed in claim 3, in which the movable element is produced as a single piece.

7. The dispenser as claimed in claim 3, in which the movable element is biassed in rotation towards a starting position by a return spring, which is advantageously produced as a single piece with the movable element.

8. The dispenser as claimed in claim 1, in which the reduced speed transmission means comprise two articulated levers that are connected together at a common junction point, a first lever being articulated on a pivot secured to the common piston and a second lever that is articulated on a fixed pivot, the common junction point being provided with an actuating cam which comes into contact with the second actuating pin.

9. The dispenser as claimed in claim 1, in which the reduced speed transmission means comprise:
a toothed wheel mounted on a fixed horizontal rotational axle,
a toothed axial pin secured to the common piston and coming into engagement with the toothed wheel in order to drive it in rotation, and
an actuating cam secured to the toothed wheel and coming into contact with the second actuating pin.

10. The dispenser as claimed in claim 1, in which the first and second maximum travels are executed both entirely and simultaneously by pushing axially on the common piston.

11. The dispenser as claimed in claim 1, in which the speed V2 of the second actuating pin is proportional to the speed V1 of the first actuating pin, such that V2=K×V1, where K is a constant less than 1.

12. The dispenser as claimed in claim 1, in which the speed V2 of the second actuating pin is not proportional to the speed V1 of the first actuating pin, such that V2=f(x)×V1, with f(x) varying between 0 and 1.
